(19) United States
(12) Patent Application Publication
(10) Pub. No.: US 2015/0088709 A1
(43) Pub. Date: Mar. 26, 2015

(54) BILL PAYMENT BY IMAGE RECOGNITION

(71) Applicants: Jayasree Mekala, Austin, TX (US); Kamal Zamer, Austin, TX (US); Praveen Nuthulapati, Austin, TX (US)

(72) Inventors: Jayasree Mekala, Austin, TX (US); Kamal Zamer, Austin, TX (US); Praveen Nuthulapati, Austin, TX (US)

(21) Appl. No.: 14/038,691

(22) Filed: Sep. 26, 2013

(51) Int. Cl. G06Q 30/04; G06Q 20/14; G06Q 20/40; G06Q 20/10

(52) U.S. Cl. CPC G06Q 30/04; G06Q 20/102; G06Q 20/14; G06Q 20/401
USPC 705/34

(57) ABSTRACT

Methods and systems for facilitating bill payment are described. A user is able to take a picture of a paper bill and have it paid. A service provider receives the image of the bill and recognizes it as a bill payment image. Relevant payment details such as the customer account number, payment amount, and the payee are extracted from the bill. The service provider determines whether these payment details are correct based on a user calendar or a location of a user device. The service provider can display these payment details to the user, and receive authorization to make the payment.

### BACKGROUND

1. Field of the Invention

The present invention generally relates to bill payment, and more particularly to using image recognition for bill payment.

2. Related Art

There are many ways that a person may pay a bill. Historically and traditionally, for example, a company, having transacted with a consumer for a product or a service, will send a paper bill by mail to that consumer, detailing the transaction and the amount due, plus the due date, among other details. The consumer keeps track of the paper bill, and writes a check against his/her bank account before or on the due date, and sends the check by mail to the company. The company, receiving the check, cashes the check and updates the consumer's record with the company, deleting the obligation.

Currently, there are many other ways that the billing/payment process may be transacted. Companies now often send bills by email, and if the consumer agrees, only by email. Payment may be made by telephone or on-line, using, for example, a credit card. Telephone payments may be posted by direct transfer from a consumer's account to the company's account. A consumer may also leverage on-line bill payment offered by most banks and other financial institutions, simply by setting up a payee configuration, and entering periodically an amount and desired payment date. The bank then pays the bill for the consumer in any one of several ways, such as by machine-generated check, or by direct transfer. Similarly, companies may offer automated telephony bill pay systems for their own clients.

These bill payment methods are time-consuming and tedious. Thus, a need exists for systems and methods that are more efficient and convenient for the consumer.

### BRIEF DESCRIPTION OF THE FIGURES

FIG. 1 is a block diagram illustrating a system for facilitating bill payment according to an embodiment of the present disclosure;

FIG. 2 is a flowchart showing a method for facilitating bill payment according to an embodiment of the present disclosure; and

FIG. 3 is a block diagram of a system for implementing one or more components in FIG. 1 according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes the use of image recognition to pay a bill. Given a paper bill statement, a user is able to take a picture of the bill and have it paid. A service provider receives the picture of the bill and recognizes the picture as a bill payment image. The service provider then determines the accuracy or validity of the bill and sets up payment on the user's behalf if the bill is correct. The service provider displays the amount to be billed, who the payment is going to, and receives authorization to make the payment from the user. In various aspects, the service provider takes into account various user factors such as their personal calendar and location histories when examining the paper bill image. The methods and systems described herein can perform image recognition on the paper bill image to recognize and extract relevant payment details such as the customer account number, payment amount, and due date.

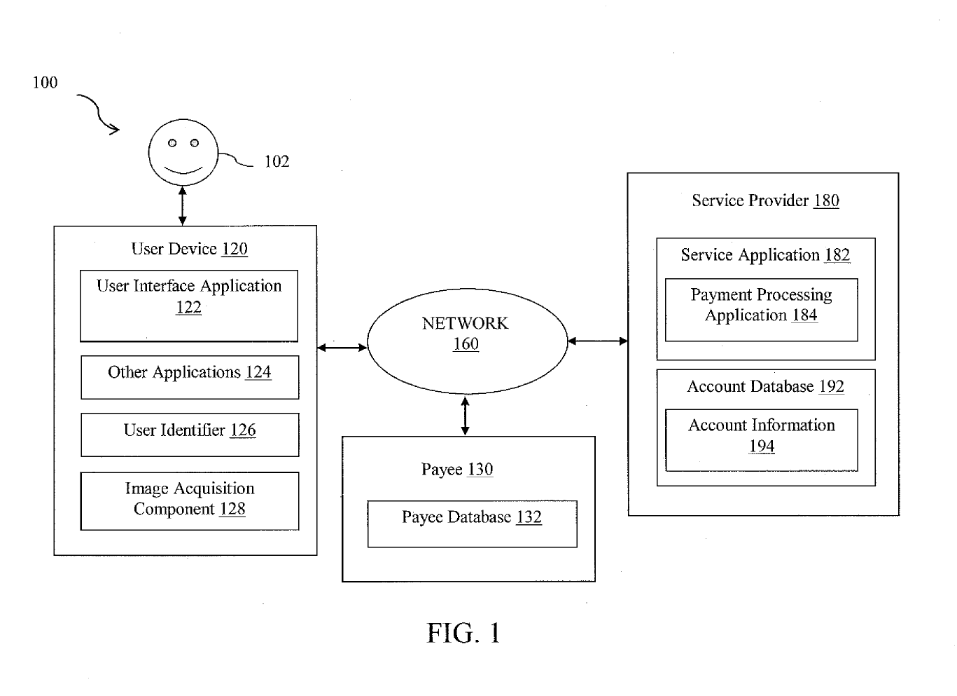

FIG. 1 shows one embodiment of a block diagram of a network-based system 100 adapted to facilitate bill payment using a user device 120 over a network 160. As shown, system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

As shown in FIG. 1, the system 100 includes a user device 120 (e.g., a smartphone), one or more payee devices 130 (e.g., network server devices), and at least one service provider server or device 180 (e.g., network server device) in communication over the network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet. As such, in various embodiments, the user device 120, payee device 130, and service provider server or device 180 may be associated with a particular link (e.g., a link, such as a URL (Uniform Resource Locator) to an IP (Internet Protocol) address).

The user device 120, in various embodiments, may be implemented using any appropriate combination of hardware and/or software configured for wired and/or wireless communication over the network 160. The user device 120, in one embodiment, may be utilized by the user 102 to interact with the service provider server 180 over the network 160. For example, the user 102 may conduct financial transactions (e.g., account transfers, bill payment, etc.) with the service provider server 180 via the user device 120. In various implementations, the user device 120 may include a wireless telephone (e.g., cellular or mobile phone), a tablet, a personal digital assistant (PDA), a personal computer, a notebook computer, and/or various other generally known types of wired and/or wireless computing devices.

The user device 120, in one embodiment, includes a user interface application 122, which may be utilized by the user 102 to conduct transactions (e.g., shopping, purchasing, bidding, etc.) with the service provider server 180 over the network 160. In one aspect, purchase expenses may be directly and/or automatically debited from an account related to the user 102 via the user interface application 122.

In one implementation, the user interface application 122 comprises a software program, such as a graphical user interface (GUI), executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160.

The user device 120, in various embodiments, may include other applications 124 as may be desired in one or more embodiments of the present disclosure to provide additional features available to user 102. In one example, such other applications 124 may include security applications for implementing client-side security features, calendar application, contacts application, location-based services application, programmatic client applications for interfacing with appropriate application programming interfaces (APIs) over the network 160, and/or various other types of generally known programs and/or software applications. In still other examples, the other applications 124 may interface with the user interface application 122 for improved efficiency and convenience.

The user device 120, in one embodiment, may include at least one user identifier 126, which may be implemented, for example, as operating system registry entries, cookies associated with the user interface application 122, identifiers associated with hardware of the user device 120, or various other appropriate identifiers. The user identifier 126 may include one or more attributes related to the user 102, such as personal information related to the user 102 (e.g., one or more user names, passwords, photograph images, biometric IDs, addresses, phone numbers, etc.) and banking information and/or funding sources (e.g., one or more banking institutions, credit card issuers, user account numbers, security data and information, etc.). In various implementations, the user identifier 126 may be passed with a user login request to the service provider server 180 via the network 160, and the user identifier 126 may be used by the service provider server 180 to associate the user 102 with a particular user account maintained by the service provider server 180.

The user device 120, in one embodiment, includes a geo-location component adapted to monitor and provide an instant geographical location (i.e., geo-location) of the user device 120. In one implementation, the geo-location of the mobile device 120 may include global positioning system (GPS) coordinates, zip-code information, area-code information, street address information, and/or various other generally known types of geo-location information. In one example, the geo-location information may be directly entered into the user device 120 by the user 102 via a user input component, such as a keyboard, touch display, and/or voice recognition microphone. In another example, the geo-location information may be automatically obtained and/or provided by the user device 120 via an internal or external GPS monitoring component. In other embodiments, the geo-location can be automatically obtained without the use of GPS. In some instances, cell signals or wireless signals are used. This helps to save battery life and to allow for better indoor location where GPS typically does not work.

In one aspect, when interfacing with the user device 120, the user 102 may elect to provide or may be prompted to provide permission for the release of geo-location information. Accordingly, the user 102 may have exclusive authority to allow transmission of geo-location information from the user device 120 to the service provider server 180. In any instance, the service provider server 180 may communicate with the user device 120 via the network 160 and request permission to acquire geo-location information from the user device 120 for geo-location based mobile commerce.

In some embodiments, the user device 120 includes an image acquisition component 128, for example, a camera (e.g., a digital camera). The image acquisition component 128 may be any device component capable of capturing an image of a paper bill.

The payee device 130, in various embodiments, may be maintained by one or more business entities. Examples of businesses entities include merchants (e.g., car dealer, salon, dry cleaner, restaurant, hotel, taxi company, airline, etc.), utility companies (e.g., electric, water, gas, or phone company), credit card companies, or any other type of entity with which the user 102 has a relationship of owing a debt to a creditor that can be expressed and paid in a monetary amount.

The payee associated with the payee device 130 may be a creditor of user 102 in the sense that user 102 owes an amount of money to the payee. The user 102 may have a customer account with the payee, which may be identified with the payee, for example, by a customer account number. The customer account number, and other pertinent information of the user account may be stored in a payee database 132.

The service provider server 180, in one embodiment, may be maintained by a transaction processing entity, which may provide processing for financial transactions and/or information transactions between the user 102 and the payee server 130. As such, the service provider server 180 includes a service application 182, which may be adapted to interact with the user device 120 and/or the payee server 130 over the network 160 to facilitate payment by the user 102 to the payee server 130. In one example, the service provider server 180 may be provided by PayPal®, Inc., eBay® of San Jose, Calif., USA, and/or one or more financial institutions or a respective intermediary that may provide multiple point of sale devices at various locations to facilitate transaction routings between merchants and, for example, financial institutions.

The service application 182, in one embodiment, utilizes a payment processing application 184 to process purchases and/or payments for financial transactions between the user 102 and the payee server 130. In one implementation, the payment processing application 184 assists with resolving financial transactions through validation, delivery, and settlement. As such, the service application 182 in conjunction with the payment processing application 184 settles indebtedness between the user 102 and the payee 130, wherein accounts may be directly and/or automatically debited and/or credited of monetary funds in a manner as accepted by the banking industry.

The service provider server 180, in one embodiment, may be configured to maintain one or more user accounts and payee accounts in an account database 192, each of which may include account information 194 associated with one or more individual users (e.g., user 102) and payees (e.g., one or more payees associated with payee server 130). For example, account information 194 may include private financial information of user 102 and each payee associated with the one or more payee servers 130, such as one or more account numbers, passwords, credit card information, banking information, or other types of financial information, which may be used to facilitate financial transactions between user 102, and the one or more payees associated with the payee servers 130. In various aspects, the methods and systems described herein may be modified to accommodate users and/or payees that may or may not be associated with at least one existing user account and/or payee account, respectively.

In various embodiments, the payment processing application 184 recognizes, analyzes and processes an image of the paper bill to obtain payment details of the bill and confirms the accuracy of the details. Payment details include the account number, a payee name, a payee address, a payment amount, a payment due date, time of transaction, or a combination thereof.

In some embodiments, the payment processing application 184 accesses the personal calendar of the user 102 on the user device 120 to verify payment details on the bill. For example, if the bill is for a service that was provided on Mar. 9, 2010, the processing application 184 checks the calendar to see if the user 102 had an appointment on that day with that payee. In other embodiments, the payment processing application 184 evaluates the location history of the user 102. The processing application 184 looks back at the location data of the user device 120 on Mar. 9, 2010 to verify that the user 102 was at the payee address on that day. By checking the personal calendar appointments and/or location history, the processing application 184 reduces the chances that the bill is fraudulent, or identifies errors that may be on the bill.

For example, the personal calendar may show the corresponding appointment, but location analysis determines that the user 102 was not at the appointment. If the bill shows a full charge and services rendered, the bill may be questioned, and the user 102 may be asked to confirm. However, if the bill shows only a missed appointment fee, then the bill may be deemed accurate. In other embodiments, payment processing application 184 determines if the user 102 received a bill from the biller in the past, and if there were errors on the past bill by accessing the user 102's bill payment history. The processing application 184 may ask the user 102 to confirm the charge if a past bill was inaccurate. The processing application 184 can also check the good or service charged for in the bill and determine whether the user 102 has a history of purchasing the good or service.

The payment processing application 184 may also verify that the biller actually has a business at the corresponding address on the bill. Other analysis may include whether the business has a record of fraudulent or incorrect charges or bills, such as by searching public databases, including the Internet, for information about the business. In yet another embodiment, the payment processing application 184 is able to access usage data for utilities and confirm that the data matches the amount charged in the bill. For instance, the processing application 184 can access cell phone usage data and compare the number of minutes charged versus the number of minutes used. In various embodiments, the payment processing application 184 verifies that the correct amount was charged by confirming that coupons, discounts (e.g., employee discounts), gift cards, and/or promotional codes were applied.

In one embodiment, the processing application 184 determines if the bill is associated with a recurring payment (e.g., a monthly phone bill), and sets up recurring payment for the bill. In other embodiments, the payment processing application 184 contacts the payee to determine if the user 102 is a current customer and confirms that the user 102 is charged the correct amount.

In one implementation, the user 102 may have identity attributes stored with the service provider server 180, and user 102 may have credentials to authenticate or verify identity with the service provider server 180. User attributes may include personal information, banking information and/or funding sources as previously described. In various aspects, the user attributes may be passed to the service provider server 180 as part of a login, search, selection, purchase, and/or payment request, and the user attributes may be utilized by the service provider server 180 to associate user 102 with one or more particular user accounts maintained by the service provider server 180.

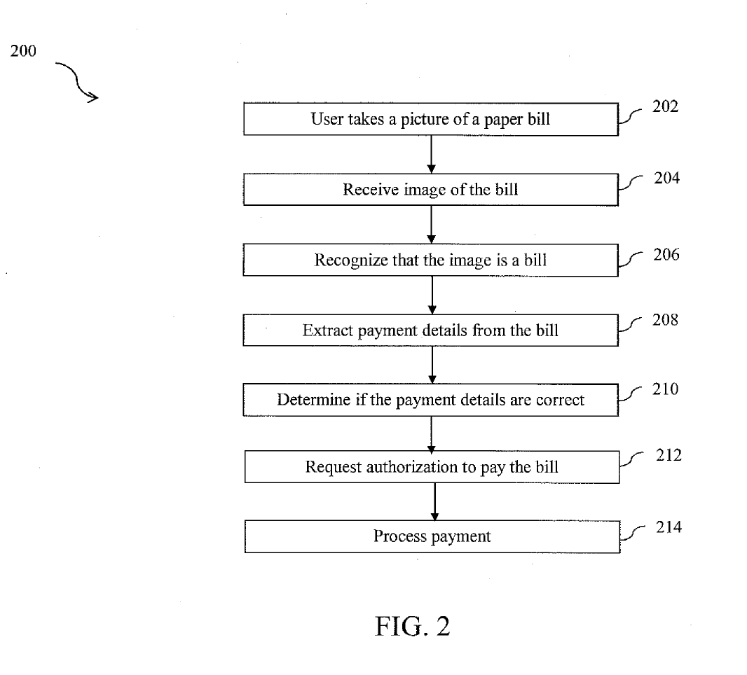

Referring now to FIG. 2, a flowchart of a method 200 for facilitating bill payment is illustrated according to an embodiment of the present disclosure. In an embodiment, at step 202, user 102 takes a picture of a paper bill using user device 120. The paper bill may be a phone bill, airline bill, restaurant bill, dry cleaning bill, or any bill for products and/or services.

At step 204, the image of the paper bill is received by the service provider server 180. In one embodiment, the image may be in an image format such as a Joint Picture Experts Group (JPEG) format, a bitmap (BMP) format, a graphic interchange format (GIF), or a Portable Network Graphic (PNG) format.

At step 206, the service provider recognizes that the image is a bill. Once the image of the paper bill is acquired, optical character recognition (OCR) or other image processing technology may be used to recognize the formatting, or objects or terms in the bill that indicate that the image is a bill. For example, words such as “payment,” “charge,” “balance,” “account number,” etc. are words commonly found on a bill. Image processing technology can also recognize identifiers that indicate where relevant information is on the bill. Examples of this information comprise the payee name, payee address, and account number. Also, other information may also be helpful such as the monthly or minimum payment amount due, due date, etc. This information may be recognized by labels that are commonly used on paper bills such as “account number” being located to the left or above the account number on the paper bill. To the extent the service provider cannot recognize needed data from the paper bill, the service provider may prompt the user 102 for such information during the process. The image of the paper bill is processed to obtain payment details from the paper bills (e.g., date, time, location, amount, business name, item purchased, service rendered, etc.).

At step 208, these payment details are extracted from the bill. The bill is “decomposed” into its components or payment details. In various embodiments, these payment details are displayed to the user 102. In some embodiments, a digital bill is created from the image of the paper bill, and includes the payment details.

At step 210, a determination of whether the payment details are correct or not is made. In one embodiment, the user 102 provides access to a user calendar to the service provider server 180. The service provider matches the payment details specified in the bill to a calendar entry located on or otherwise associated with the user device 120. The service provider taps into the personal calendar of the user 102 to match the date, time, and location of a past appointment with the information on the bill. For example, the user 102 may specify that he or she intended to be at the doctor's office on Monday at 2 PM, and the service provider server 180 checks the bill to determine if this information corresponds to what is listed.

In another embodiment, the service provider server 180 checks the location history to verify that the user was at the location on the date specified in the bill. A past physical location of the user device 102 is compared to the location of the payee to determine if they match or are within a certain predefined distance. If it is determined that the locations match, the service provider server 180 proceeds with the method.

The user 102 may release geo-location information to the service provider by, for example, setting release parameters. In one aspect, the user geo-location information includes user information related to a physical location or position of the user device 120, which is passed to the service provider server 180 via the network 160. The user geo-location information may include GPS coordinates (e.g., longitude and latitude) inherent to the user device 120, such as a mobile cellular phone, and/or zip-code information. The user geo-location information may include user identifier information identifying the user 102. The user 102 may manually set geo-location information, such as a zip code and/or longitude and latitude coordinates.

In some embodiments, the service provider server 180 determines if the bill is associated with a recurring payment (e.g., monthly, weekly, daily, etc.). A recurring payment is typically associated with credit card payments, auto payments, utilities, and mortgage payments. If it is determined that it is a recurring payment, the service provider can set up a recurring payment schedule. For example, the service provider may present the user 102 with an option to authorize recurring payment for future charges. The user 102 may be able to set up automatic recurring payments in which the service provider server 180 makes a payment to a payee for the full outstanding balance, the minimum required payment, or another amount specified by the user 102. In this way, once the user 102 sets up the payment preferences for a payee, the service provider server 180 can make the payments to the payee without further action by the user 102, which provides a significant convenience to the user 102.

In other embodiments, the service provider server 180 contacts the payee specified in the bill to determine if the user 102 is a current customer. The service provider server 180 can contact the payee server 130 to access the user 102's usage statistics to see if the statistics match what the user 102 is billed for. For example, when the payee is a phone company, the service provider server 180 can retrieve minutes used by the user 102 from the payee server 130, and compare it to what the user 102 is billed for.

At step 212, if the bill is correct, the service provider notifies the user 102 that the bill is valid, and requests authorization from the user 102 to pay the bill. In certain embodiments, the user 102 has a limited amount of time to authorize payment of the bill. If the user 102 does not authorize bill payment within a given time period, the service provider may operate to cancel the transaction.

At step 214, the payment is processed. For example, the service provider may collect the amount of the payment from the user 102 (e.g., via a credit card or bank payment from user 102 to the service account of user 102 with the service provider). The service provider may then provide a payment to the payee 130 from the service account of the user 102.

### EXAMPLES

Two specific examples will now be described. The first example deals with a payment associated with a dentist bill that takes into account calendar and location information. A user takes her son to the dentist for teeth cleaning and receives a paper bill in the mail for $10. To pay the bill, the user would typically either call the number on the bill or go to the website on the bill and manually enter her credit card number.

In the present case, the user takes a picture of the bill, which is sent to the service provider. The service provider digests the picture and uses image recognition technology to understand that the image is a picture of the bill, the amount of the bill to be paid, to whom, the due date of the bill, etc. The service provider takes into account the user's previous calendar appointments to determine if she had an appointment relating to “dentist,” “teeth cleaning,” or similar keywords. The time of the transaction on the bill is noted to understand if the time the services were performed coincide with an appointment on the user's personal calendar. The service provider also examines the user's location history to see if the user was in the location specified by the bill, as well as if the address on the bill matches any locations the user was in within a period of time from the transaction date. For example, if the bill reads “Date of service: Monday, July 15^{th} at 11:30 am,” and the user's location history contains movements around the dentist office's address from 11 am to 12:30 pm, then the service provider can conclude with some confidence that that the user was at the dentist office at a time which she was billed for the service. The user can then authorize the amount to be paid. Use of the calendar appointments and location history help reduce fraudulent bills.

In the second example, payments are made for a service bill, and the service provider discovers recurring payment opportunities. A user changes his mobile company for his cellphone to AT&T®. The user gets his new mobile bill for $100 in a paper statement. The user does not want to go through the hassle of calling customer service to pay the bill, using the AT&T® website, or writing a check. Instead, the user takes a picture of the bill, and the service provider determines that this is a bill from AT&T®, the amount due is $100, and the amount is due at the end of the month. The service provider uses APIs provided by AT&T® to discover if this bill is a recurring bill. If the statement is part of a recurring billing cycle, the user can have the service provider set up recurring monthly bill payments on the user's behalf. The user will no longer have to take a picture of his paper phone bill because the service provider can set up a payment system for the bill. The service provider can also make an API call to AT&T® to determine if the user is a current customer of AT&T®. The service provider can make another API call to AT&T® to access the user's actual minutes/data usage and compare it against what is billed in the user's current statement. These and further API calls can help reduce bill inaccuracies and fraud.

The methods and systems described herein use image recognition to discover a bill for a user. A paper statement is recognized and subsequent factors like the user's calendar, location history, and usage statistics can be used to verify payment details. Verification of payment details helps to reduce fraudulent billing.

The methods and systems described herein make it easier, faster, and more convenient for a user to pay a bill. The user does not need to provide credit card or bank information over the phone or on a website, or write and mail a check. The present disclosure allows the user to pay for a bill when they open the mail rather than to wait and pay later. Moreover, the payee may receive payment faster than through normal bill pay.

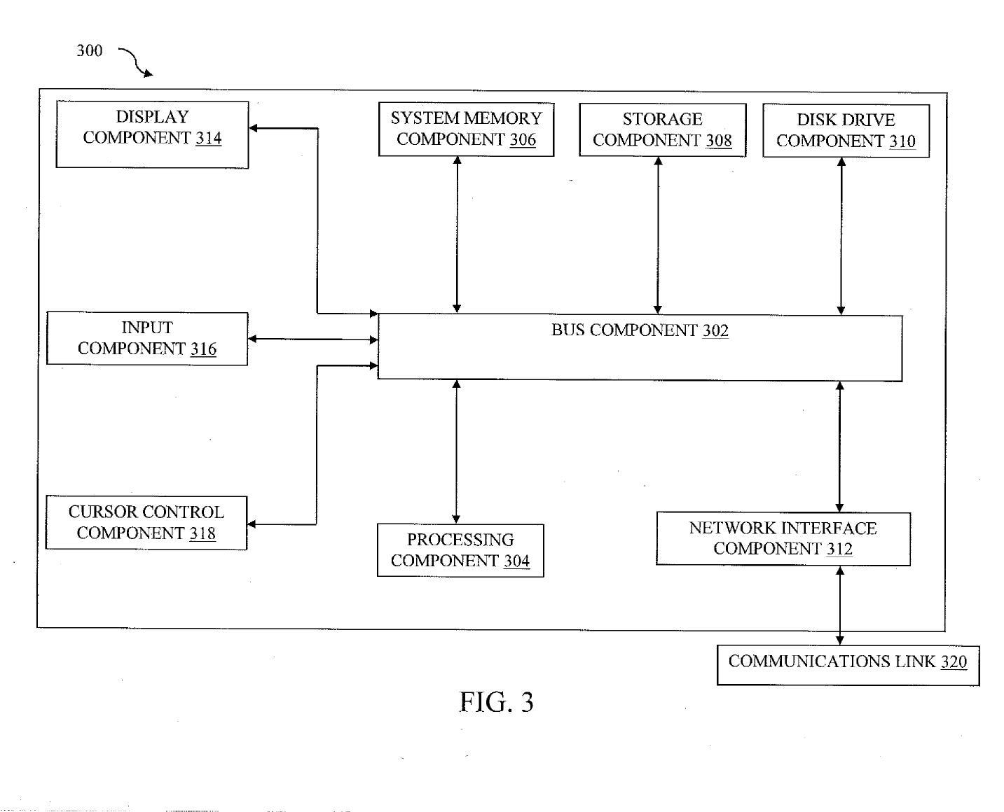

Referring now to FIG. 3, a block diagram of a system 300 is illustrated suitable for implementing embodiments of the present disclosure, including user device 120, one or more payee servers or devices 130, and service provider server or device 180. System 300, such as part of a cell phone, a tablet, a personal computer and/or a network server, includes a bus 302 or other communication mechanism for communicating information, which interconnects subsystems and components, including one or more of a processing component 304 (e.g., processor, micro-controller, digital signal processor (DSP), etc.), a system memory component 306 (e.g., RAM), a static storage component 308 (e.g., ROM), a network interface component 312, a display component 31.4 (or alternatively, an interface to an external display), an input component 316 (e.g., keypad or keyboard), and a cursor control component 318 (e.g., a mouse pad).

In accordance with embodiments of the present disclosure, system 300 performs specific operations by processor 304 executing one or more sequences of one or more instructions contained in system memory component 306. Such instructions may be read into system memory component 306 from another computer readable medium, such as static storage component 308. These may include instructions to process financial transactions, make payments, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 304 for execution. Such a medium may take many forms, including but not limited to, non-volatile media, volatile media, and transmission media. In various implementations, volatile media includes dynamic memory, such as system memory component 306, and transmission media includes coaxial cables, copper wire, and fiber optics, including wires that comprise bus 302. Memory may be used to store visual representations of the different options for searching, auto-synchronizing, making payments or conducting financial transactions. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 300. In various other embodiments, a plurality of systems 300 coupled by communication link 320 (e.g., network 160 of FIG. 1, LAN, WLAN, PTSN, or various other wired or wireless networks) may perform instruction sequences to practice the disclosure in coordination with one another. Computer system 300 may transmit and receive messages, data, information and instructions, including one or more programs (i.e., application code) through communication link 320 and communication interface 312. Received program code may be executed by processor 304 as received and/or stored in disk drive component 310 or some other non-volatile storage component for execution.

In view of the present disclosure, it will be appreciated that various methods and systems have been described according to one or more embodiments for facilitating bill payment.

Although various components and steps have been described herein as being associated with user device 120, payee server 130, and service provider server 180 of FIG. 1, it is contemplated that the various aspects of such servers illustrated in FIG. 1 may be distributed among a plurality of servers, devices, and/or other entities.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a memory device storing user financial account information; and
one or more processors in communication with the memory device and operable to:
receive an image of a paper bill;
recognize the image as a bill;
extract payment details from the bill;
determine whether the payment details are correct based on at least information from a user calendar or a location of a user device;
receive authorization for payment of the bill; and
process the payment.

2. The system of claim 1, wherein the payment details comprise account number, a payee name, a payee address, a payment amount, a payment due date, date of transaction, time of transaction, or a combination thereof.

3. The system of claim 2, wherein the one or more processors determines whether the payment details are correct by verifying the date of transaction, the time of transaction, and/or the payee address with a user's past calendar appointment.

4. The system of claim 2, wherein the one or more processors determines whether the payment details are correct by verifying the date of transaction, the time of transaction, and/or the payee address with a user's past location.

5. The system of claim 1, wherein the one or more processors is further operable to determine if the bill is a recurring bill.

6. The system of claim 5, wherein the one or more processors is further operable to set up recurring bill payments.

7. The system of claim 1, wherein the one or more processors determines whether the payment details are correct by verifying usage statistics with a payee.

8. A method for facilitating bill payment, comprising:
receiving, by one or more hardware processors of a service provider, an image of a paper bill;
recognizing the image as a bill;
extracting payment details from the bill;
determining whether the payment details are correct based on at least information from a user calendar or a location of a user device;
receiving authorization for payment of the bill; and
processing the payment.

9. The method of claim 8, wherein the payment details comprise account number, a payee name, a payee address, a payment amount, a payment due date, date of transaction, time of transaction, or a combination thereof.

10. The method of claim 9, wherein determining whether the payment details are correct comprises verifying the date of transaction, the time of transaction, and/or the payee address with a user's past calendar appointment.

11. The method of claim 9, wherein determining whether the payment details are correct comprises verifying the date of transaction, the time of transaction, and/or the payee address with a user's past location.

12. The method of claim 8, further comprising determining if the bill is a recurring bill.

13. The method of claim 12, further comprising setting up recurring bill payments.

14. The method of claim 8, wherein determining whether the payment details are correct comprises verifying usage statistics with a payee.

15. A non-transitory machine-readable medium comprising a plurality of machine-readable instructions which, when executed by one or more processors, are adapted to cause the one or more processors to perform a method comprising:
receiving an image of a paper bill;
recognizing the image as a bill;
extracting payment details from the bill;
determining whether the payment details are correct based on at least information from a user calendar or a location of a user device;
receiving authorization for payment of the bill; and
processing the payment.

16. The non-transitory machine-readable medium of claim 15, wherein the payment details comprise account number, a payee name, a payee address, a payment amount, a payment due date, date of transaction, time of transaction, or a combination thereof.

17. The non-transitory machine-readable medium of claim 16, wherein determining whether the payment details are correct comprises verifying the date of transaction, the time of transaction, and/or the payee address with a user's past calendar appointment, a user's past location, or a combination thereof

18. The non-transitory machine-readable medium of claim 15, wherein the method further comprises determining if the bill is a recurring bill.

19. The non-transitory machine-readable medium of claim 18, wherein the method further comprises setting up recurring bill payments.

20. The non-transitory machine-readable medium of claim 15, wherein determining whether the payment details are correct comprises verifying usage statistics with a payee.
